(19) United States
(12) Patent Application Publication
(10) Pub. No.: US 2009/0059038 A1
(43) Pub. Date: Mar. 5, 2009

(54) Image magnifier for the visually impaired

(76) Inventors: Paul J. Seakins, Christchurch (NZ); Jonathan D. Cartwright, St. Martins (NZ); David J. Haughey, Christchurch (NZ); David N. Lovegrove, Christchurch (NZ); Darryl J. Best, Christchurch (NZ)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/578,486

(22) PCT Filed: Apr. 13, 2005
(86) PCT No.: PCT/NZ05/00076

§ 371 Date: Apr. 16, 2008

(30) Foreign Application Priority Data
Apr. 13, 2004 (NZ) 532300
Jun. 30, 2004 (NZ) 533875

(51) Int. Cl. H04N 5/262; H04N 5/64

(52) U.S. Cl. 348/240.99; 348/836; 348/E05.128; 348/E05.055

(57) ABSTRACT

A image magnifier for the vision impaired which magnifies the image of face up source material (13) placed in the visual field of the camera (15) and displays the magnified image on a display (20). One embodiment includes a static high-resolution image mode and a second live video mode. The controller (29) provides different lighting appropriate for each mode. In a further embodiment the magnifier is transportable. Each part (17, 14, 16) is hinged (18, 19) to the other parts (17, 14, 16) allowing it to be folded into a compact lightweight form to be portably carried. In a still further embodiment the magnifier includes shielding for the lighting to minimise or avoid specular reflections.

### BACKGROUND OF THE INVENTION

1. Field of the Invention

This invention relates to a viewing device to enable people with low-vision to view objects or source material, including reading text, handwritten or printed, viewing pictures and physical objects, and particularly, but not solely, relates to a foldable device including a camera, a visual display unit (VDU), a variety of light sources and a control unit to activate a variety of viewing modes.

2. Summary of the Prior Art

Low vision is defined as a condition where ordinary eye glasses, lens implants or contact lenses cannot provide sharp sight. Low vision can be caused by a variety of eye problems. Macular degeneration, diabetic retinopathy, inoperable cataracts, and glaucoma are but a few of the conditions that cause low vision. Individuals with low vision find it difficult, if not impossible, to read small writing or to discern small objects without high levels of magnification. This limits their ability to lead an independent life.

One method of providing greater magnification is the use of a Video Magnifier. Such devices use a camera to image an object that is to be viewed. Video images taken from the camera are continuously displayed on a VDU, at a sufficient level of magnification for the user. The low vision user can then use their remaining sight to its best advantage when viewing very small objects or writing.

An example of existing prior art is shown in FIG. 1. It consists of three basic parts—a VDU 1, a head unit 2, and a base unit 3. The VDU 1 is mounted on the head unit 2, which is in-turn mounted above the base unit 3 using a vertical pillar 4. The VDU 1 may be of any conventional type such as a cathode ray tube or a fiat-panel screen with a liquid crystal display panel. The object is placed on the base unit 3, which consists of a base and, in many cases, also an X-Y table 5, being so defined because the table 5 is moveable on an X-Y axis. The X-Y table 5, moves on runners 6 and 7 in the horizontal directions X and Y. The object is placed on the table 5 and scanned past the field of view of a camera 8. The X-Y table 5 requires a lot of empty space around the base 3 for the table-top to move through. The need for space around the X-Y table makes it difficult to place VDU's or other objects in the immediate vicinity.

A camera 8 is part of the head unit 2 and consists of a mirror 11, zoom lens 9 and image sensor 12. The zoom lens 9 provides a variable level of magnification or zoom of the image projected onto the image sensor 12. As the level of magnification is increased, the field of view on the page decreases. The image acquired by the camera is processed by circuitry located in head unit 2, and then displayed on VDU 1. The camera may be a colour or monochrome model, the latter being used in low cost video magnifiers. A light source (not shown in FIG. 1) is located in head unit 2 and shines down onto X-Y table 5 to illuminate the source material.

User controls 10 are usually found on the front panel. A control allows the user to increase and decrease the level of magnification from typically 3 times to 45 times. Older models have control to manually adjust focus while more recent models provide a motorised automatic-focus system. Another control often found on the front panel allows the user to select a viewing mode. The view modes available would usually include photo, text, false colour, and inverse colour modes. The photo mode simply displays a full colour image of the scanned objects on the VDU 1. Text, false colour and inverse colour modes enhance the image by using pixel level threshold filtering, and display the object as a bitonal colour image. False colour mode allows for easier reading of text by changing the object's colours to colours that are easier to read and the inverse colour mode allows for inversion of text and background colour to decrease image intensity and thus reduce eye strain. This list of features is by no means exhaustive of the features that could be incorporated into a video magnifying system.

To use the prior art video magnifier described above, a user needs to place the source material face up on X-Y table 5. Part of the source material will be magnified on the VDU 1. When reading text the user then needs to move the X-Y table 5 to the left and right while their eye follows the text. Moving the X-Y table 5 in this way can be tiring for the user's arms and their eyes. Scanning the viewing area across the text takes a great deal of concentration that could be better utilised for reading and comprehension. This movement also requires a certain level of coordination and dexterity that is often absent in elderly people. An example of this is disclosed in U.S. Pat. No. 3,819,855.

The design of the prior art video magnifier also causes several limitations to the viewing area. Ergonomically, it is best to have VDU 1 as low as practicable so that the user doesn't have to tilt their head upwards in use. The optimal height of the VDU 1 therefore sets a maximum height for head unit 2, and limits the working distance between head unit 2 and base unit 3. The maximum viewing area on the page is physically limited by the working distance and the maximum viewing angle of the zoom lens. Typically the maximum viewing area of such a system is about 1/10 of the area of an A4-sized page, so it is not possible to view a whole A4 page at once.

The requirement to support VDU 1, which may be a heavy CRT, requires head unit 2, base 3 and pillar 4 to be of strong rigid metal construction. Therefore the device is typically large, heavy and not easily transportable.

A number of low vision image magnifiers have been described. WO0036839 discloses a low vision image magnifier for upward facing source material utilising a video camera. The camera is mounted on a stand above the source material and can view the entire page or view selected sections of the page. The camera lens points down from the stand and is moveable by hand. This requires a high level of dexterity from the user.

Baum Retec AG manufactures a image magnifier for the vision impaired incorporating a flat-panel display under the name Baum Visio PC. This device is described in EP1096779. The camera is mounted on a rigid stand above the base, comprising a head unit, two uprights at the back and a flat base unit. The flat-panel display is mounted on two arms that pivot at the rear of the head allowing the display's height to be adjusted. Pneumatic gas-struts hold the flat-panel display at the chosen height. The arms attach to the sides of the flat-panel display, and the angle of the display can be adjusted by pivoting it on the arms. The camera is motorised within the head, allowing its position to be moved in two axes. A hand controller is used to adjust the functions of the unit, including the camera position. This low-vision device incorporates an integral flat-panel display that has height and tilt adjustment, but it doesn't fold down to make itself smaller for transportation. It has a rigid stand, incorporating the head, upright and the base unit.

The Videomatic Uno from Reinecker Reha-Technik GmbH is another prior art low-vision magnifier. In this device the camera and lights are mounted on a rigid stand above the base, comprising a head unit, two uprights at the back and a flat base unit with an X-Y table. A flat-panel display is mounted to the front of the head unit by two pivots at either side of the bottom of the display. The display may be swung upright for normal use or swung back and down so that the display covers the top of the head unit and faces up. This reduces slightly the size of the magnifier for transportation, but because the stand stays rigid and cannot be folded the magnifier is too large to be easily transported. Further the front of the flat-panel display is unprotected in the folded position and therefore can easily be broken. In use the display has tilt adjustment but no height adjustment and therefore users of different heights cannot set the optimal height of their display.

The Andromeda from Ash Technologies is a low-vision magnifier with an in-built flat-panel screen. This device is similar in construction to the Reinecker Uno, but the camera and lights are mounted to the rear face of the flat-panel display instead of being in a head unit. The advantage of this design is that it allows the camera to gain extra height when the display is in the working position, so the rigid bracket at the rear doesn't need to be as high as with the Uno.

In construction this device has a flat base unit with two rigid stands (one each side) that support the flat-panel display. The rigid stands each comprise a right-angled metal bracket that rises from the rear of the base and comes forward to the flat-panel pivots, which are located above the front of the base unit. The bottom of the flat-panel display is mounted to the two pivots, one on each side. The display may be swung upright for normal use or swung back and down so that the display covers the top of the head unit and faces up. This reduces slightly the size of the magnifier for transportation, but because the stand stays rigid and cannot be folded the magnifier is too large to be easily transported. Further the front of the flat-panel display is unprotected in the folded position and therefore can easily be broken. In use the display has tilt adjustment but no height adjustment and therefore users of different heights cannot set the optimal height of their display.

The Prisma from Ash Technologies is a low-vision magnifier that folds right down to reduce the size for transportation. It consists of a flat base unit, rear section and head unit that are connected via flexible friction hinges. The head unit contains a camera and lights. In use the rear section is upright from the rear of the base, and the head unit is parallel to the base. To make the device smaller for transportation, the user folds the rear section forward along the base, and the head unit folds upwards so that it is in line with the rear section. In this way the whole unit is folded flat along the base unit for transportation.

The Prisma uses an external monitor and has no provision for a flat-panel display. It folds for transportation, but this action takes place by folding the rear section and head into a straight line in the axis of the base. The hinges between the head unit, rear section and base are friction hinges and do not lock in any defined orientation.

The VisAble Image from Betacom is a low-vision magnifier with a built-in flat-panel display, mounted on a rigid metal stand that curves up from the rear of the base. The flat-panel display has tilt adjustment, but no height adjustment. The base has an X-Y table with limited movement. The camera is mounted directly behind the flat-panel display and looks straight down. White LEDs are used for lighting the page. The device doesn't fold down to increase portability.

Although not a low-vision image magnifier, a related form of high-resolution face up scanner is used in museums and the like for scanning manuscripts. This is performed face up due to the delicate nature of such documents. Such scanners use linear sensors that are scanned across the image of the page. U.S. Pat. No. 5,616,914 provides an example of such a device.

Another sort of image magnifier is used for presentations, and consists of a camera mounted on a stand above a base, with light sources mounted on separate stands off to each side of the base. U.S. Pat. No. 5,594,502 is an example of such a system, where the camera and light sources can all fold down to make the device compact for transportation.

### SUMMARY OF THE INVENTION

It is an object of the present invention to provide a transportable viewing device to allow persons with low-vision the ability to view objects that goes some way to overcoming the abovementioned disadvantages in the prior art or which will at least provide the public with a useful choice.

Accordingly in a first aspect the present invention consists in a low-vision apparatus that displays the image of an object, said apparatus comprising:

a support including a connection for a surface on which to place the object to be viewed;

a head unit connected to said support, said head unit in use substantially above the object to be viewed;

a camera, integral or engaged with said head unit in use capturing a visual field including at least part of said object;

a display integral or engaged with said head unit and/or said support displaying at least part of said captured visual field; and

lighting integral or engaged with said head unit and/or said support for illuminating said visual field.

Preferably said apparatus further comprising:

a base upon the object to be viewed is in use placed; wherein said support connected to said base; and wherein said display and said lighting are integral or engaged with said head unit, said base unit and/or said support.

Preferably said base is hingably connected to said support.

Preferably said support is hingably connected to said head unit.

Preferably said display is hingably connected to said head unit.

Preferably said hinges are self locking at one or more orientations and a manually unlocking mechanism.

Preferably the back of said base is hinged to the bottom of said support.

Preferably the top of said support is hinged to the back of said head unit.

Preferably the back of said display is hinged to the front of said head unit.

Preferably said display is detachable from said head unit.

Preferably said display, said head unit, said support and said base fold relative to one another to fold said low-vision apparatus to a compact configuration.

Preferably said apparatus includes a handle to carry said apparatus during transportation.

Preferably said apparatus when folded is portable.

Preferably said apparatus is lightweight.

Preferably said apparatus when folded can be carried using one hand.

Preferably said lighting includes one or more sets of light sources consisting of one or more lights mounted on one or more of the said head unit, said support or said display.

Preferably said camera is on said head unit, oriented in use to point the visual field at the object to be viewed.

Preferably said camera is on said support, oriented in use to point the visual field at the object to be viewed.

Preferably said camera operates in single capture and repetitive capture modes.

Preferably one or more said sets of light sources is selectively activated by a controller dependent on said modes.

Preferably said lighting is shielded.

Preferably said lighting includes a specular reflection shield.

Preferably said shield comprises at least one first linear polarised filter to polarise the light shining on said base, and said camera has at least one second linear polarised filter mounted in front of it, whereby the polarisation angle of said second linear polarised filter is oriented at 90 degrees to that of said first linear polarised filter.

Preferably said first linear polarised filter comprises a plurality of polarising filters.

Preferably said shield comprises a mechanical louver in front of said sets of light sources.

Preferably said shield comprises a prismatic lens in front of said sets of light sources.

Preferably said sets of light sources are shielded so that each light source illuminates the opposite side of said visual field than the side they are mounted on.

Preferably said low-vision apparatus includes a data processing unit connected intermediate of said display means and said camera, said processing unit defining said visual field as a set of pixels and a subset of said set of pixels as a window-of-interest and said low-vision apparatus including a selection tool to select said subset of pixels on said visual field which constitutes the window-of-interest.

In a second aspect the present invention consists in a low-vision apparatus that displays the image of an object, said apparatus comprising:

a support structure

a camera attached to said support structure, in use capturing a visual field about said object, including at least one first linear polarised filter;

a display attached to said support structure displaying at least part of said captured visual field; and

lighting attached to said support structure for lighting said visual field, including at least one second linear polarised filter, whereby the polarisation angle of said second linear polarised filter is oriented at 90 degrees to that of said first linear polarised filter.

Iin a third aspect the present invention consists in a low-vision apparatus that displays the image of an object, said apparatus comprising:

a support structure;

a camera attached to said support structure, in use capturing a visual field about said object;

a display attached to said support structure displaying at least part of said captured visual field;

lighting attached to said support structure for lighting said visual field; and

a controller selectively activating said camera into either a single capture mode or a repetitive capture mode, and selectively activating said lighting depending on said modes.

In a fourth aspect the present invention consists in A low-vision apparatus that displays the image of an object, said apparatus comprising:

a support structure;

a camera attached to said support structure, in use capturing a visual field about said object;

a display attached to said support structure displaying at least part of said captured visual field; and

lighting attached to said support structure for lighting said visual field, including a specular reflection shield.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The invention consists in the foregoing and also envisages constructions of which the following gives examples only.

### BRIEF DESCRIPTION OF THE DRAWINGS

One preferred form of the present invention will now be described with reference to the accompanying drawings in which;

Preferred forms of the present invention will now be described with reference to

FIG. 1 is a side elevation illustrating a video magnifier representative of the prior art,

FIG. 2 is a side elevation illustrating the preferred embodiment of the video magnifier of the present invention,

FIG. 3 is a side elevation illustrating the preferred embodiment of the video magnifier of the present invention in a folded position,

FIG. 4 is a side elevation illustrating the preferred embodiment of the video magnifier of the present invention in a partially folded position,

FIG. 5 is a side elevation illustrating the preferred embodiment of the video magnifier of the present invention in a further partially folded position,

FIG. 6 is a side elevation illustrating the preferred embodiment of the video magnifier of the present invention in a further folded position,

FIG. 7A is a side elevation illustrating the lighting aspects of the preferred embodiment of the video magnifier of the present invention,

FIG. 7B is a three dimensional view illustrating the lighting aspects of the preferred embodiment of the video magnifier of the present invention,

FIG. 8 is a front view illustrating the lighting aspects of the preferred embodiment of the video magnifier of the prior art video magnifier,

FIG. 9 is a further front view illustrating the lighting aspects of the preferred embodiment of the video magnifier of the present invention,

FIG. 10A is a diagram illustrating a lighting filter and the effect of the filter on light rays,

FIG. 10B is a diagram illustrating an alternative lighting filter and the effect of the filter on light rays,

FIG. 10C is a diagram illustrating an alternative lighting filter and the effect of the filter on light rays,

FIG. 10D is a diagram illustrating an alternative lighting filter and the effect of the filter on light rays,

FIG. 11 is a plan view of the controller of the present invention,

FIG. 12A is an exploded assembly view of a pin lock hinge system,

FIG. 12B is a section view of a pin lock hinge system,

FIG. 13A is an exploded assembly view of a snap lock ball hinge system,

FIG. 13B is a section view of a snap lock ball hinge system,

FIG. 14A is an exploded assembly view of a latch-and-lock hinge system,

FIG. 14B is a three-dimensional assembled view of a latch-and-lock hinge system,

FIG. 15A is an exploded assembly view of a dog clutch hinge system, and

FIG. 15B is a section view of a dog clutch hinge system.

FIGS. 16a and 16b are representative diagrams illustrating the use of linear polarised filters to prevent specular reflections being seen off glossy surfaces,

FIG. 17 is a side elevation illustrating the lighting aspects of the preferred embodiment of the video magnifier of the present invention.

### DETAILED DESCRIPTION OF THE PREFERRED EMBODIMENTS

The image magnifier for the vision impaired of the present invention magnifies the image of face-up source material placed in the visual field of the camera and displays the magnified image on a VDU or other display means. Preferably there are two different camera modes. The first mode is a static mode whereby the camera captures and stores a single high-resolution image of the source material. This high-resolution image can be manipulated and displayed on the display means. The second mode is a live mode whereby the camera captures consecutive lower resolution images at a high frame rate so as to provide full motion video. Using the live mode the low-vision user can move the view around the source material and magnify a desired section of interest. Preferably the same camera and the same apparatus are used for both the static and live modes.

In static mode the software controlling the system captures and manipulates a high-resolution image. This allows precise pixel data to be obtained from the image and manipulated for optimum viewing by the low-vision user. The system allows the image magnifier to manipulate what is displayed. Forms of manipulation include changing the orientation of the source material image, or the method of displaying of characters from the image on the display. Further manipulation of the image sensor data is performed using Optical Character Recognition (OCR). Using OCR extends the utility of the magnifier for poor or no vision users by providing an output that allows for Braille or speech to be generated.

### Physical Structure

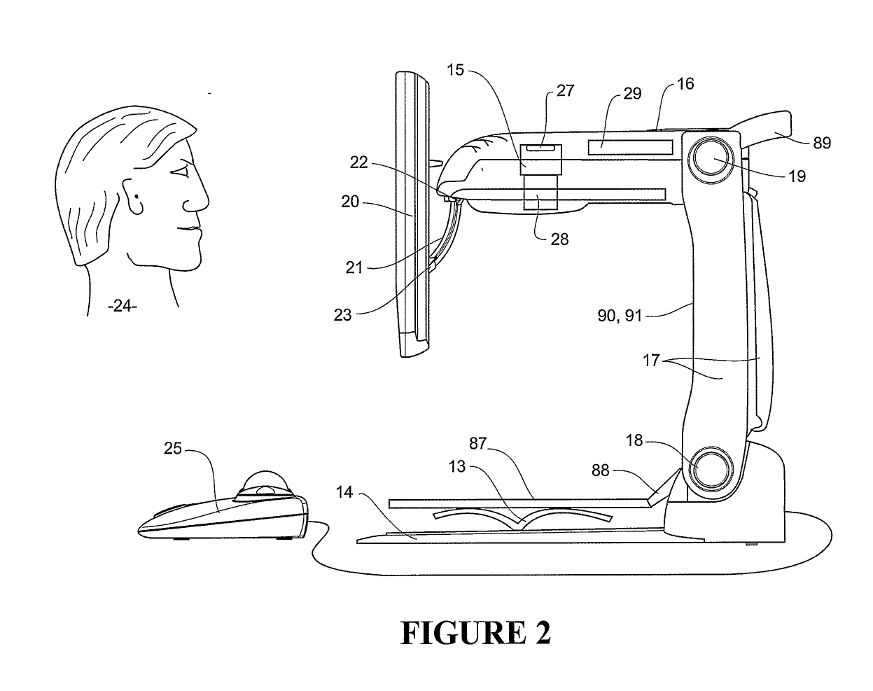

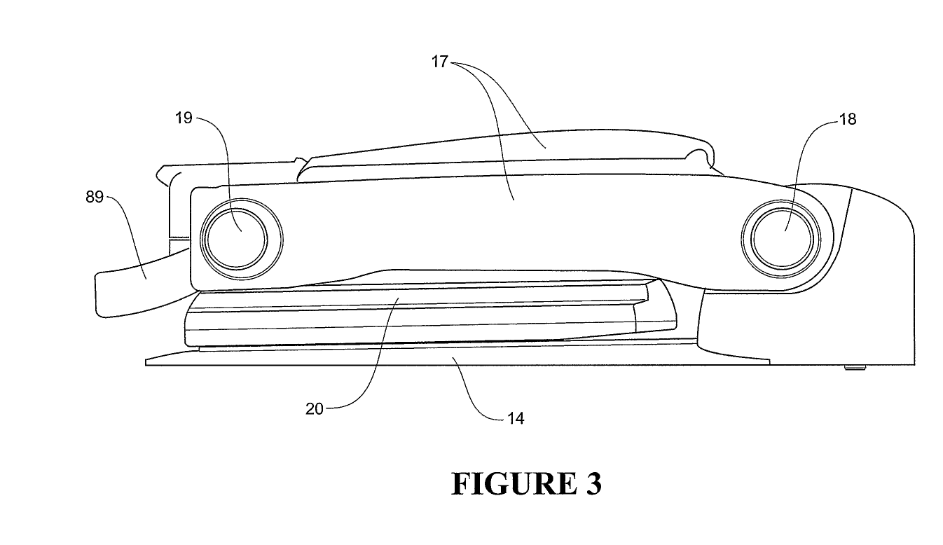

FIGS. 2 and 3 depict the preferred embodiment of the present invention of a image magnifier system for the visually impaired which is preferably transportable. FIG. 2 shows a side elevation of the invention in an operating position and FIG. 3 shows it in a completely folded position, ready for transportation. Referring to FIG. 2, the main body consists of parts that are preferably configurably connected with respect to each other. A support unit 17 is connected to a base unit 14 preferably by a hinging mechanism 18. In turn a head unit 16 preferably connects to the support unit 17 by hinging mechanism 19. Both hinge mechanisms 18 and 19 are self-locking in the operating or upright position as shown in FIG. 2. The hinge mechanisms can be manually unlocked so that the product folds into the folded position for transportation, as shown in FIG. 3.

Alternatively the support unit may include a connection to attach to a table or flat rigid surface, to take the place of the base unit. The connection may include permanent attachment or temporary clamping system as are known in the art.

### Flat-Panel Display

An optional flat-panel display 20 can also be attached to the product as shown in FIG. 2. The flat-panel display 20 is attached to flat-panel ann 21 via a hinge-joint 23. In turn, flat-panel arm 21 is connected to the front of the head unit 16 via a hinge-joint 22. In use the flat-panel display 20 faces a user 24. Hinge-joints 22 and 23 are preferably friction torque hinges, although they may also have locking mechanisms or adjustable end stops, to allow the user to adjust the height and angle of the flat-panel display 20 to an ergonomic position. Hinge joints 22 and 23 alternatively may also have another mechanism to allow the user 24 to rotate the flat-panel display 20 around its central axis 90 degrees, so that the display is better suited for displaying images in portrait rather than landscape orientation. This further allows for a more compact configuration for the device when it is folded.

Alternatively the display may attach to the support unit or the base unit.

### Controls

In the preferred device a hand-operated controller 25 plugs in at the rear of base unit 14. However other control methods are possible, including a wireless control panel, controls mounted on the unit, or the use of a touch screen.

### Folding Method

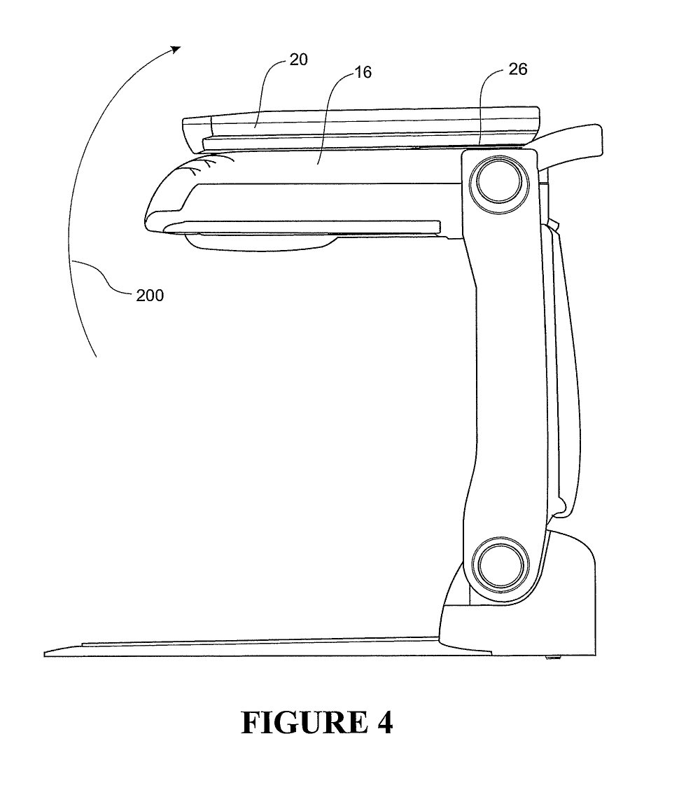

The folding method for the device can now be described. Firstly, the flat-panel display 20 is folded up and around so that it sits on top of the head unit 16 as shown in FIG. 4. Arrow 200 shows the direction of movement of the flat panel display. To allow this to occur hinge joints 22 and 23 are rotated, when friction hinges are used the motion is against their friction. In this position, the flat-panel display 20 may be retained to head unit 16 via retaining mechanism 26. This locking mechanism must be released manually by the user to unfold the unit flat-panel display 20 from the head unit 16.

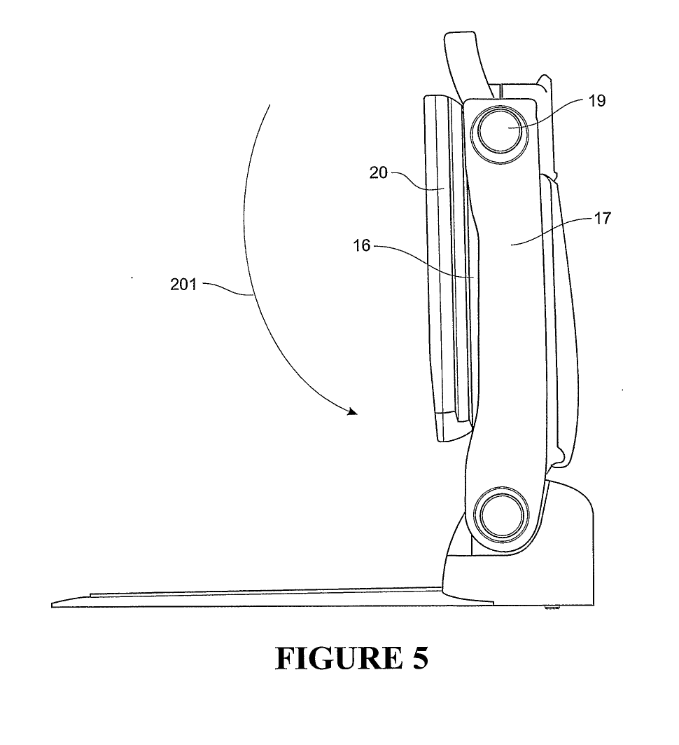

The second step to fold up the device is to fold head unit 16 around hinging mechanism 19 so that it nestles inside support unit 17, which is hollow. This is shown in FIG. 5. The direction of movement is shown by arrow 201. Preferably hinging mechanism 19 locks in both the open and closed positions, and requires the user to release the lock (e.g. by pressing a button) to fold or unfold head unit 16.

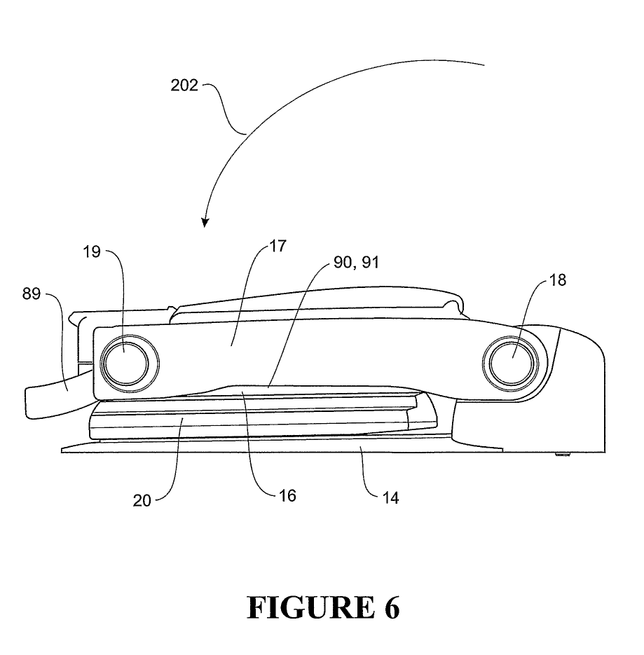

The last step is to fold support unit 17 around hinging mechanism 18 so that the unit folds flat and flat-panel display 20 is against base unit 14 as shown in FIG. 6. Preferably hinging mechanism 18 locks in both the open and closed positions, and requires the user to release the lock (e.g. by using a button) to fold or unfold support unit 17. The direction of folding is shown by arrow 202.

In the completely folded position the front of the flat panel display 20 faces the top of base unit 14, which protects it from damage. The unit when folded is small and suitable for transportation or packaging.

### Operation of the Product

Referring again to FIG. 2, the user places source material 13 for example a book to read on the base unit 14 facing upwards towards the camera 15. Camera 15 is held above the source material 13 by head unit 16 and rear section 17. An image sensor 27 is in vertical alignment with a lens 28, both the lens 28 and the image sensor 27 being enclosed within the camera 15. Light reflected from the source material 13 is focussed by lens 28 and forms an image of the source material 13 on the image sensor 27. The image is captured by image sensor 27, and is then transmitted to the image processing and control electronics 29 for processing into a visual format suitable for a low vision user. The processed image is then displayed on flat-panel display 20.

The software program and associated hardware for controlling the video magnifier is located in the image processing and control electronics 29 and is described in detail in WO03083805 which is herby incorporated by reference.

### Two Camera Modes

There are two modes that the camera 15 can be operated in. The first mode is live mode (similar to video recording), where camera 15 continuously captures images of source material 13 at a fast frame rate. This gives real-time image capture, and is particularly important for those activities where motion is followed, such as writing or threading a needle. The shutter time of camera 15 needs to be short (e.g. less than 0.02 sec) to capture motion accurately, and this may require a high level of illumination on source material 13. In the preferred embodiment the camera shutter time is synchronised with the mains power frequency to preclude any image brightness flicker that may result from room lighting that shines on source material 13.

The second mode is static mode, where camera 15 takes a single image of a static (not moving) source material 13. Since there is no requirement to capture fast motion the shutter time may be lengthened to any convenient time (e.g. less than 1 sec) that will capture an image of good quality, and a lower level of illumination on source material 13 may be tolerated. Many low-vision users prefer to have a lower light level in their field of view because it is distracting and can reduce their quality of vision. For this reason it is advantageous to use the lowest level of illumination that will allow camera 15 to produce a good quality image of the source material 13.

The two camera modes could be achieved using two different cameras. However, in the preferred embodiment of the device both camera modes are provided using one camera.

### Two Lighting Levels

It can be seen that the two different camera modes may require different light levels for optimum operation. Live mode requires a higher light level because of the short shutter time required to ‘freeze’ source material motion, whereas static mode can use either a high or low level light but it is preferable to use a low light level because of the low-vision users' increased tolerance for this. Therefore the low-vision magnifier uses a lighting system that has two light levels—a bright level for live mode and dimmer level for static mode. This lighting system may consist of a single light source that is operated at two or more light levels, a plurality of light sources that are operated at two or more light levels, or a plurality of light sources that are switched on or off to give a plurality of light sources.

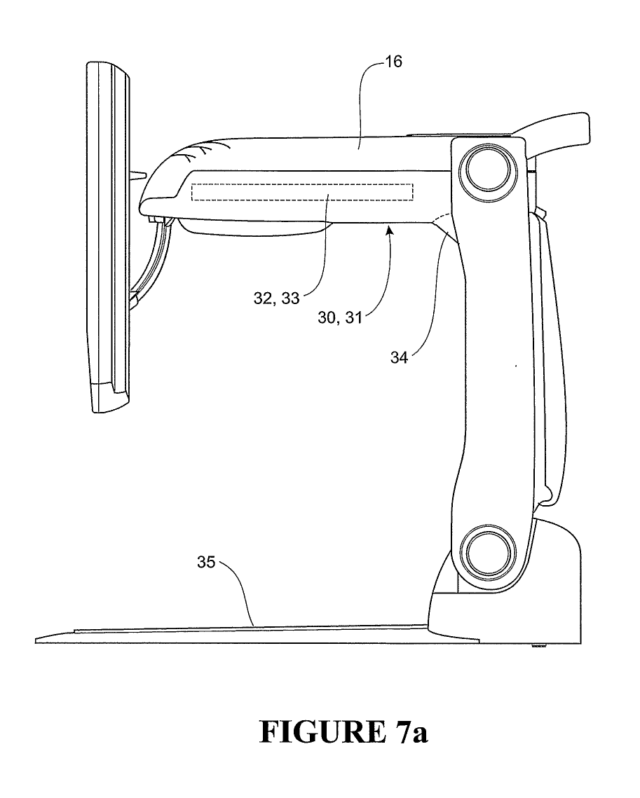

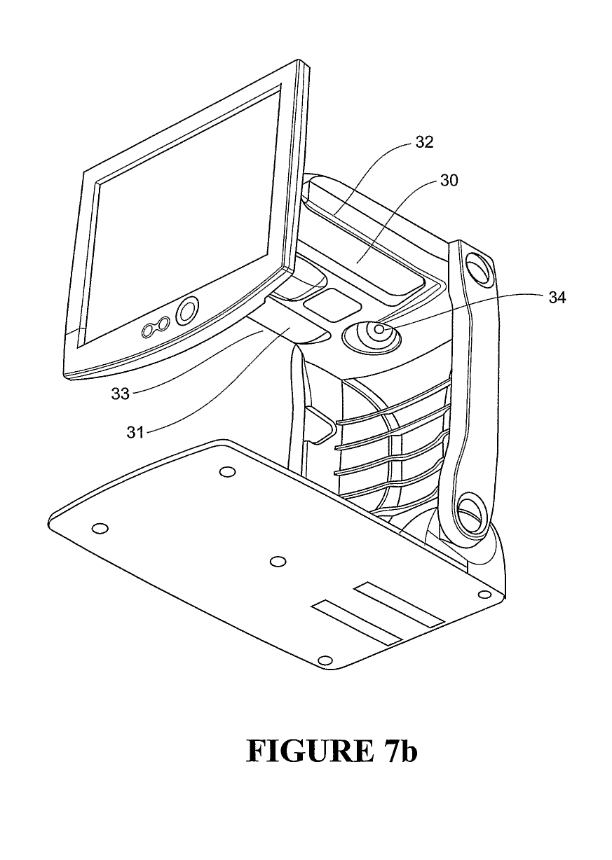

Lighting used in the preferred embodiment of the invention is shown in FIGS. 7A and 7B. In this embodiment two sets of lights are used, a pair of fluorescent tubes 32, 33 that are used for static mode, and a single reflector halogen 34 that is turned on in live mode to augment the fluorescent lighting and provide a higher light level in the centre of the viewing area 35. Preferably the lighting is integral of attached to the head unit. Alternatively the lighting is attached to said base unit or said support unit.

### Avoiding Specular Reflections

Preferably the lighting system of the present invention avoids specular reflections that may occur when light rays from the lighting system reflect off a glossy or shiny object or document in the viewing area and enter the camera 15. This is seen as a bright glare in the image that distorts the image and reduces contrast. The present invention includes means to reduce or eliminate the problem of specular reflection off glossy or shiny material, or block those light rays that lead to specular reflection.

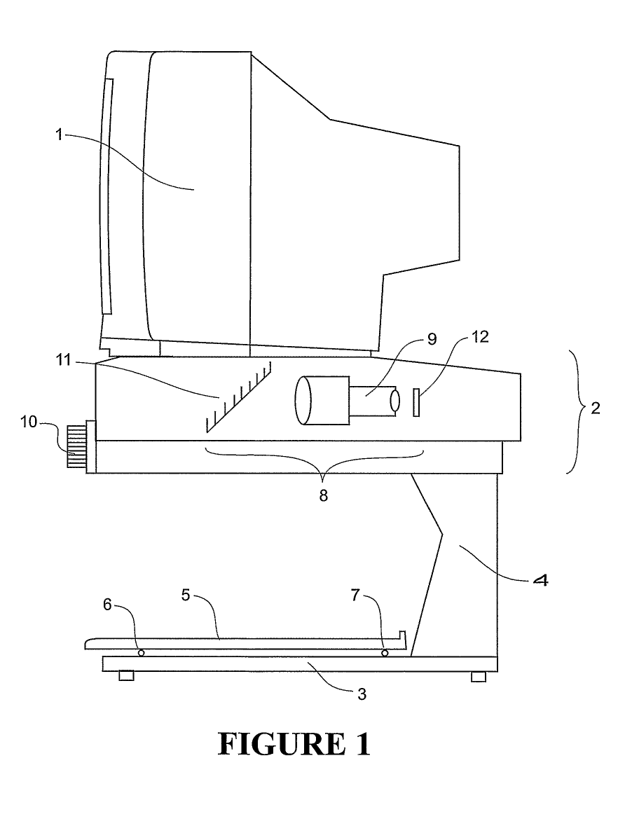

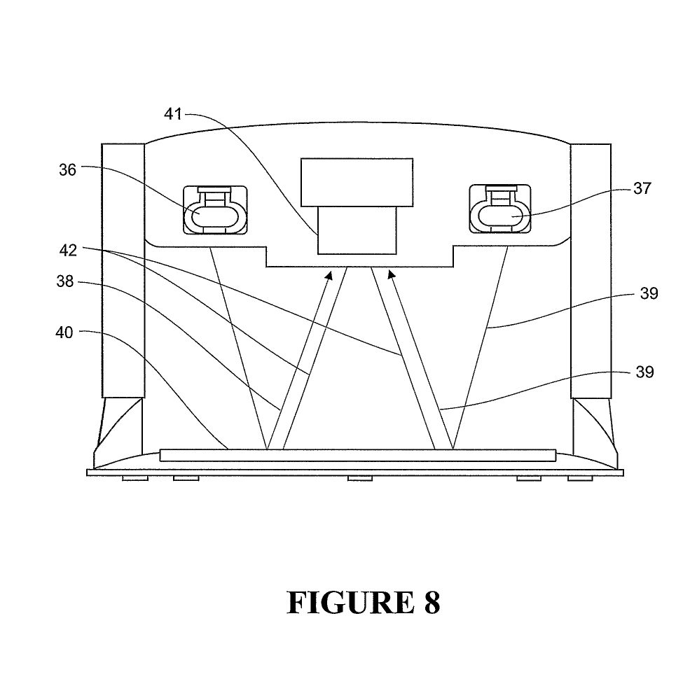

In most conventional low-vision magnifiers, such as seen in FIG. 1, the problem of specular reflection is avoided by using a camera with a small field of view, and by positioning lighting sources far away from the camera. This can be seen in FIG. 8. Lighting sources 36, 37 generate light rays 38, 39 that would cause specular reflection. However the angles of these light rays are such that they reflect off viewing material 40 at a sufficient angle to camera 41 that they fall outside its narrow field of view 42, and hence are not seen by camera 41.

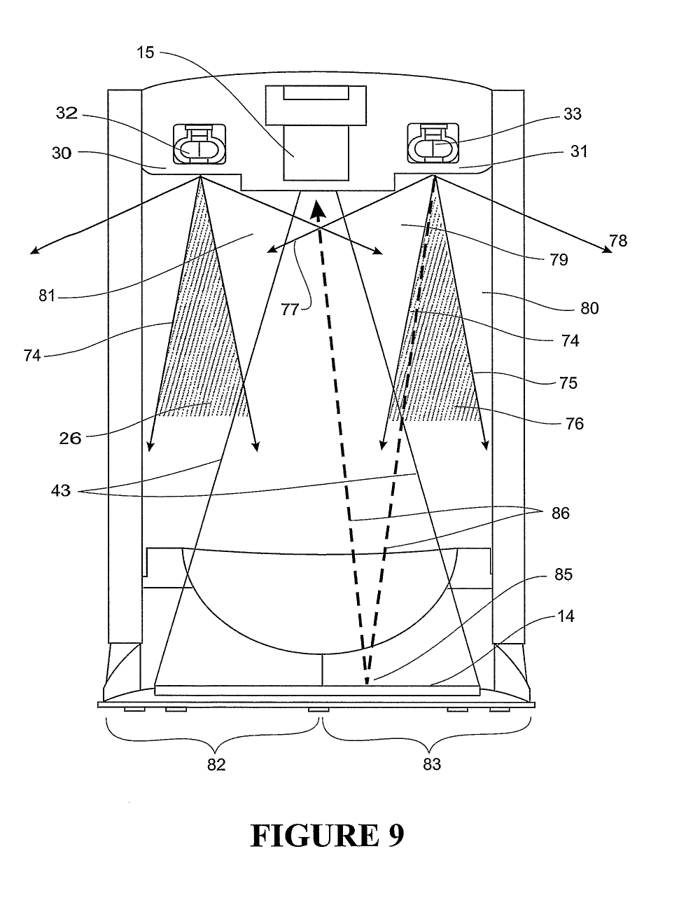

In the present invention seen in FIGS. 7a, 7b, 9 the camera 15 is used with a wide field of view 43 so that a full page can be viewed and captured in static mode. It is not practical to position the fluorescent lighting sources 32, 33 at a sufficient angle to the camera to avoid specular reflection in the usual way. To do so would have resulted in an awkward mechanical setup with fluorescent tubes located at a low level, which would have restricted access to the viewing area and caused long shadows off non-flat surfaces. To avoid the specular reflections the angled light rays that lead to this effect are blocked. These light rays are the ones that will normally reflect off the viewing area halfway between the camera and the lighting source.

### Polarised Filters

One way to remove specular reflections is to use linear polarised filters that are mounted over both the lighting and the camera, and where the angle of polarisation of the linear polarised filter on the camera is oriented at right angles to the angle of polarisation of the linear polarised filter on the lighting. This method exploits the property that specular reflections (e.g. off a glossy printed page) retain their angle of polarisation, while diffuse reflections (e.g. off a piece of white paper) contain light rays of all polarised orientations.

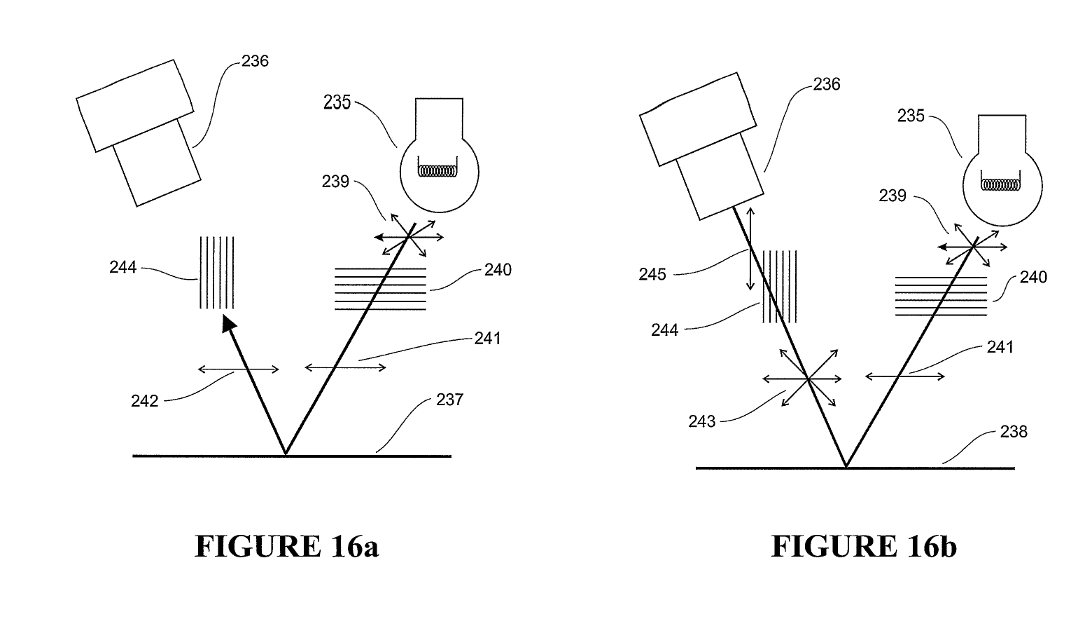

Referring to FIG. 16a and 16b, a representative lighting source 235 and camera 236 are mounted facing an object to be imaged which may have a glossy surface 237 (in FIG. 16a) or a diffusely reflective surface 238 (in FIG. 16b). The lighting source 235 creates rays of all polarisation angles 239, but the linear polarised filters 240 that are mounted over the lighting will filter out all polarisation angles except that corresponding to the orientation of those polarised filters 241. If light 241 shines on a glossy surface 237, those light rays that reflect towards the camera 236 will retain their polarisation angle 242 and will be blocked by the linear polarised filter 244 on the camera, because this has been oriented with a polarisation angle of 90 degrees to the linear polarised filters 240 on the lighting. In this way specular reflected light 242 is completely blocked by the polarised filter 244 of the camera, and hence camera 236 cannot see the specular reflection. However if the light 241 reflects off a diffuse surface 238, those light rays 243 that reflect towards the camera 236 will contain all angles of polarisation 243, and hence the linear polarised filter 244 on the camera will allow through those rays 245 which match its orientation, and these can be seen by camera 236.

In the method just described, the camera can look at a variety of objects or documents and will see only the surface markings of the object or document that are reflected in a diffuse manner. Direct specular reflections from the lighting source are rejected by the polarisers. This system is particularly useful with imaging of printed documents, which may be very diffuse (e.g. matt black ink on white paper) or a mixture of diffuse and specular (e.g. glossy printed material).

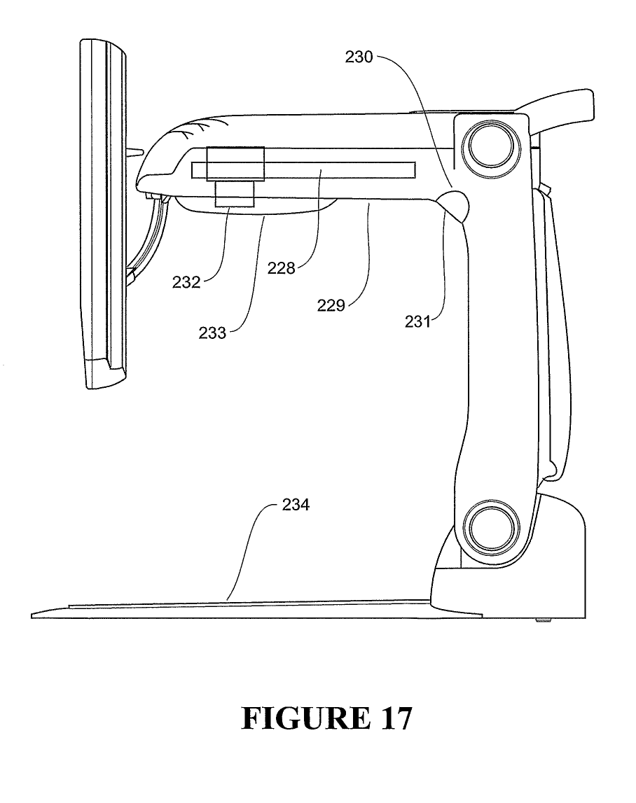

FIG. 17 shows an embodiment of the present invention with polarisers fitted as described above. Fluorescent lamp 228 has a linear polarised filter 229 mounted below it. Similarly halogen lamp 230 has a linear polarised filter 231 fitted in front of it. Polarised light from lamps 228 and 230 will reflect off source material place on base unit 234 and reflect back to camera 232, which has another linear polarised filter 233 fitted below it. The orientation of polarisation of linear polarised filter 233 is at 90 degrees to that of linear polarised filters 229 and 231.

### Prismatic Lens

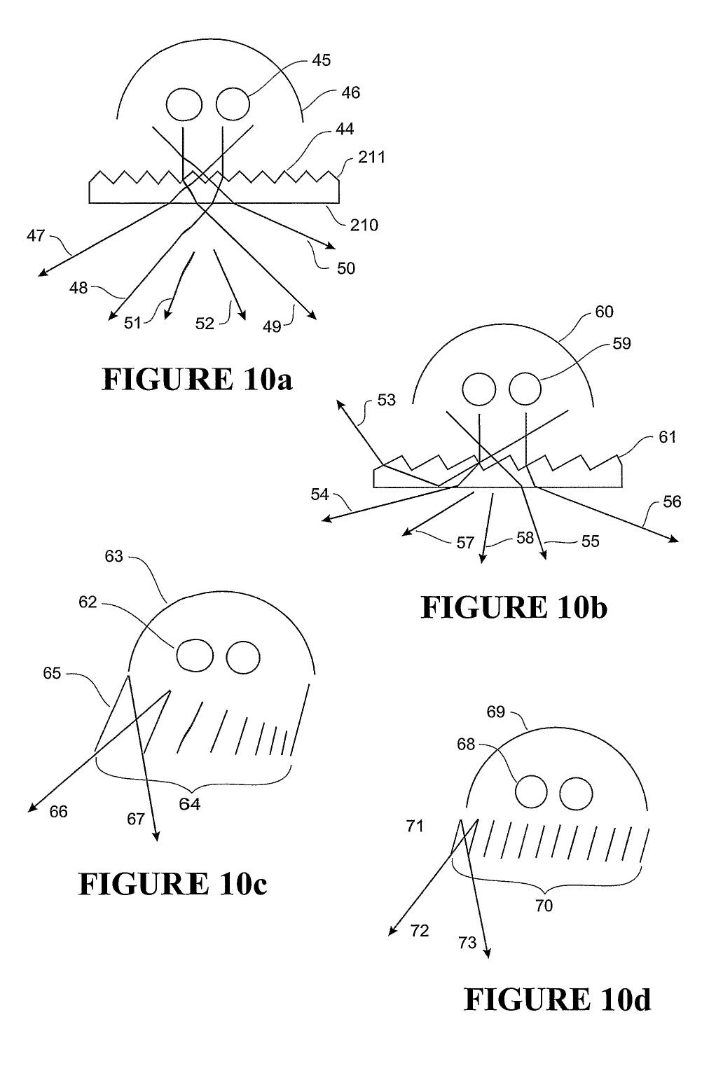

Another way to block the rays is to use a transparent prismatic lens in front of the light source to block the angular rays that cause specular reflection. Two options are shown in FIGS. 10a and 10b. FIG. 10a shows a prismatic lens 44 that is mounted in front of fluorescent tubes 45 with a reflector 46 behind it. The prismatic lens 44 is made of a transparent material and has a flat side 210 facing away from the light source 45 and a prismatic side 211 that faces toward the light source 45. The prismatic side 211 consists of many prisms, which run parallel to the axis of the fluorescent tube, and has a profile in the other axis of regular triangular prisms that have a vertex of 90 degrees and the prism sides are angled at 45 degrees with respect to the other side. Light rays 47-50 from the fluorescent tube 45 arrive at many different angles, and are refracted through one side or the other of the prism, such that they leave in two general directions to the right or left. No rays will exit in the range of angles between 51 and 52, because they fall within the critical angle of refraction for the prismatic surface of the lens 44.

FIG. 10b shows an alternative prismatic lens 61 that accepts light rays 53-56 from a variety of angles, but only allows light to pass in the range outside of angles between rays 57 and 58. The prismatic lens consists of many prisms, which run parallel to the axis of the fluorescent tube 59. In the other axis the profile consists of regular triangular prisms that have a 90 degree vertex, but the sides are angled at other than 45 degrees to the opposite side.

### Mechanical Louvre

An alternative means to remove light rays that lead to specular reflection is by using a mechanical louvre in front of the light source to block these rays. Two options for this are shown in FIGS. 10c and 10d. In FIG. 10c a fluorescent tube 62, reflector 63 and louvre 64 are used. The louvre 64 is composed of a plurality of vanes 65 that block light rays that are outside the angles of light rays 66 and 67. In FIG. 10d a fluorescent tube 68, reflector 69 and louvre 70 are used. The louvre 70 is composed of a plurality of vanes 71 that block light rays that are outside the angles of light rays 73 and 74. The louvres block those rays that are unwanted, but in order for them to work well they must be made of dark non-reflective material. Otherwise rays that are reflected from the vanes of the louvre will be seen as specular reflection.

### Avoiding Specular Reflections

FIGS. 7a, 7b and 9 illustrate the preferred embodiment of the lighting system for avoiding specular reflection with a large field of view. Fluorescent tubes 32, 33 have prismatic lenses 30, 31 mounted in front. These prismatic lenses have the profile as shown in FIG. 10a.

Referring to FIG. 9, fluorescent lamp 33 generates light rays in all directions, but prismatic material 31 blocks some of these light rays. This causes the light to be spread over two ranges of angles, with no light rays emerging from the lighting assemblies in an angular range oriented at right angles to the prismatic lens. In particular light rays between angles 74 and 75 are blocked by prismatic material lens 31, causing a dark patch 76. Two light beams 79 are formed, one between angles 74 and 77 and the other between angles 75 and 78. Fluorescent lamp 32 and prismatic lens 30 generate their own, identical light profile.

Therefore light beam 79 from the right-hand fluorescent lamp 33 lights the left-hand side 82 of the base 14, and the light beam 81 from the left-hand fluorescent lamp 32 lights the right-hand side 83 of the base 14. The lighting is arranged so that the dark patch from each prismatic lens takes up half of the viewing area to be illuminated, including the region where specular reflection would otherwise occur. A dotted line 86 shows the ray of light from lamp 33 that would otherwise cause specular reflection to camera 15, however these rays are blocked by prismatic material 31. In this way each of the prismatic lenses 30, 31 illuminate the opposite half of the viewing area and no specular reflection occurs.

Referring again to FIGS. 7a and 7b, there are two sets of light sources, the fluorescent tubes 32, 33 and a reflector halogen 34. Live mode may require a higher light level than static mode, and in the preferred embodiment a halogen reflector lamp 34 is used to boost the light level in this mode. The halogen lamp 34 may be activated on its own in live mode, or in conjunction with the fluorescent lamps 32, 33. In static mode, it is expected that halogen lamp 34 will not be necessary.

In the preferred embodiment camera 15 has a narrower field of view when used in live mode compared to static mode, and therefore a reduced viewing area. Specular reflection from halogen lamp 34 is avoided in the conventional way, because the reduced field of view causes the specular reflection point on the base to lie outside of the viewing area for live mode.

### Page Hold-Down

The static image capture made allows the user to capture an image of a book to view on the screen. It is necessary to hold the book flat and still so that the pages can be seen properly without any motion blur during the shutter time. The user could hold the book open and flat but this can introduce fingers and shadows into the image. A better way is to place a flat sheet of clear plastic or glass over the book, which would hold the book under its own weight. Flat sheets are sometimes used in prior art low-vision magnifiers for the same purpose.

To facilitate this, in an alternative embodiment the image magnifier includes a page hold-down assembly as shown in FIG. 2. The page hold-down assembly consists of a sheet of clear plastic or glass 87 that is attached to base assembly 14 by a flexible linkage 88. The user can lift clear sheet 87 up and place it on reading material 13 to hold the material it flat and still under the weight of the assembly. If the page hold-down is not required, then it can be folded down flat onto base assembly 14 and objects placed on top of the assembly to be viewed.

### Handle

To help with transportation of the folded device a loop handle 89 is attached to the rear of head unit 16 as shown in FIGS. 2, 3 and 6. This allows the image magnifier to be carried like a suitcase when folded as shown in FIG. 6. The handle 89 is located directly above the centre of gravity when the folded device is held by the handle 89 in the manner of a briefcase.

In addition to the handle 89 two finger recesses 90, 91 are provided, one at each side of the rear section 17. The recesses are best seen in FIG. 6. These allow the user to grip the folded unit using one hand on either side and pick it up.

### Hand Controller

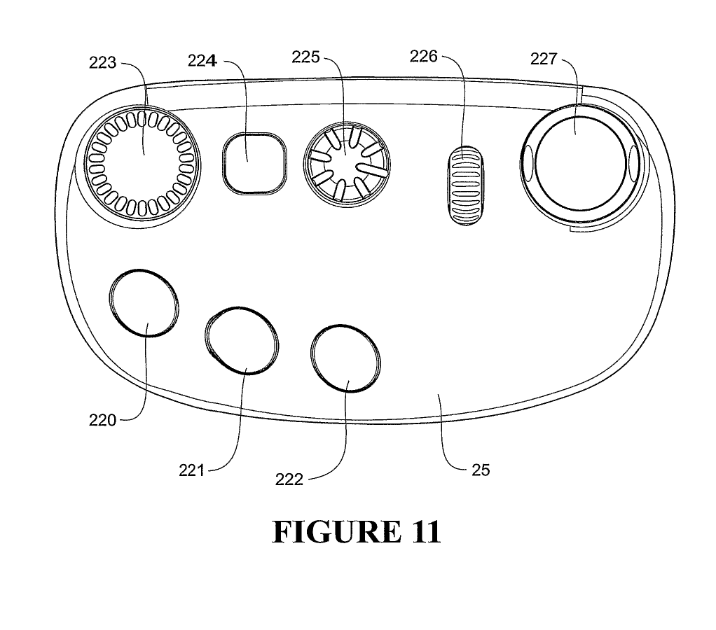

The design of this device is such that does not require an X-Y table. This is important because it reduces the amount of desk space required around the base unit. Instead of using an X-Y table, the preferred method of operating the device is by using a hand controller 25, as shown in FIGS. 2 and 11. The hand controller 25 allows the user to do many functions, including but not limited to navigating around a captured image, navigating around a captured image that has been rearranged, navigating through menus, and adjusting screen colours and representations. Due to the lack of X-Y table the operator can place the hand controller directly in front of base unit 14, or they can use it in any convenient position.

The hand controller 25 may have many controls 220 to 227. In the preferred embodiment these include a trackball, wheel, knobs and buttons; however the use of other controls can be envisaged such as a mouse, slider controls or a joystick.

Static mode allows the user to capture an image of a whole A4 page and then navigate around the image using the hand controller 25. Therefore the main camera unit can be placed anywhere that is convenient to the user (e.g. at the back of a desk, to the side, or under the desk.) The user can place the hand controller and VDU in any convenient position. This flexibility in set up is important to low-vision users, as they may only have usable vision at certain angles, and physical space is often limited.

### Removable Flat-Panel Display

Referring to FIG. 2, in an alternative embodiment flat-panel display 20 is removable from the main unit. To enable this hinge joints 22 or 23 can be disengaged, to allow the user to remove the flat-panel display. The removed display could then be used on the user's lap or attached to a separate stand. In this way the user can move the display to the optimum position for viewing. In a further alternative flat-panel display 20 would include touch screen capabilities and thus the display and controls are similar to those of an electronic book. Because flat-panel display 20 is still attached to the main unit via signal and power cables, the user will need to sit very close to the main unit.

In a further alternative flat-panel display 20 is connected via a wireless interface to the main unit, allowing the user more flexibility in their reading position. In this embodiment the flat-panel display 20 includes a power source, so that the connection with the main unit could be severed completely. In a further alternative the flat-panel display 20 could include memory and a processor so that a user could scan a number of pages or images and then review them later, anywhere that was convenient, for example on a bus. Such that the flat-panel display 20 is usable independently of the main unit.

### Hinge Design

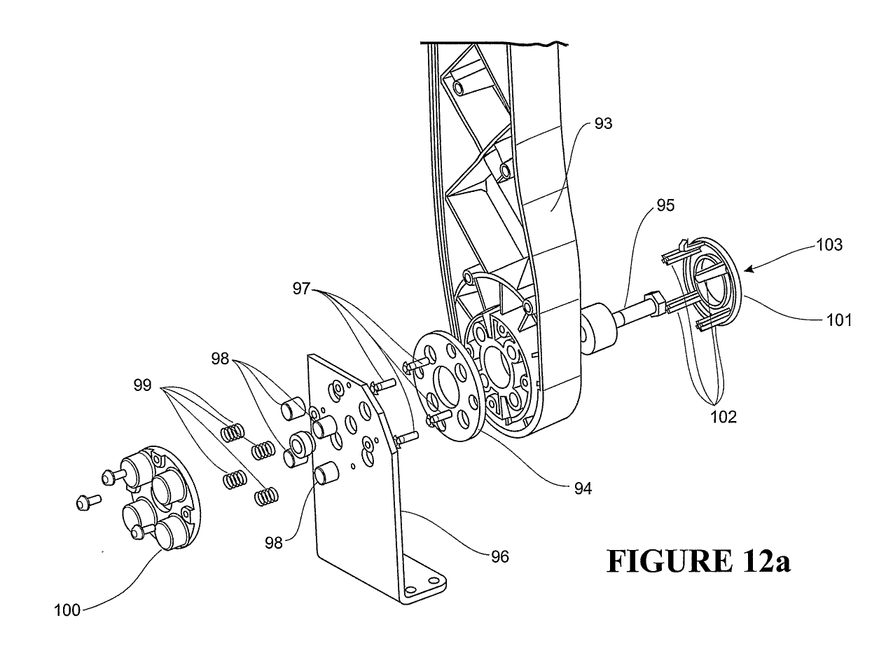

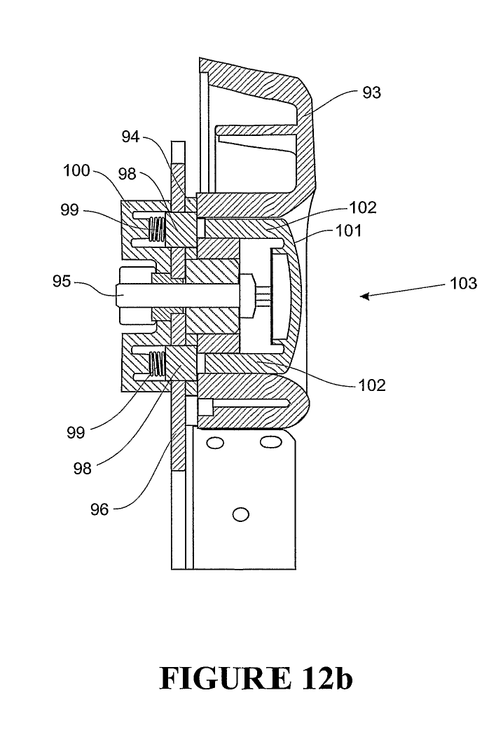

The image magnifier is portable because of the capability to fold down into a small package for transportation. Therefore the design of hinges 18 and 19 (see FIGS. 2-6) is very important. Four options for the hinge design are shown in FIGS. 12-15.

FIGS. 12a and 12b depict a pin-locking system. Arm 93 has a plate 94 screwed securely to it using screws 97. Arm 93 can rotate with respect to bracket 96 around the axis defined by bolt 95. To lock the hinge four locking pins 98 engage with the four holes in plate 94 and bracket 96. The locking pins 98 are held in place by four springs 99 that press against spring retainer 100. When the user presses locking button 101, four pins 102 press against locking pins 98 causing locking pins 98 to disengage from between plate 94 and bracket 96. At this point arm 93 and plate 94 can rotate with respect to bracket 96, and after 90 degrees of rotation the locking pins 98 can spring into place to lock plate 94 and bracket 96 again.

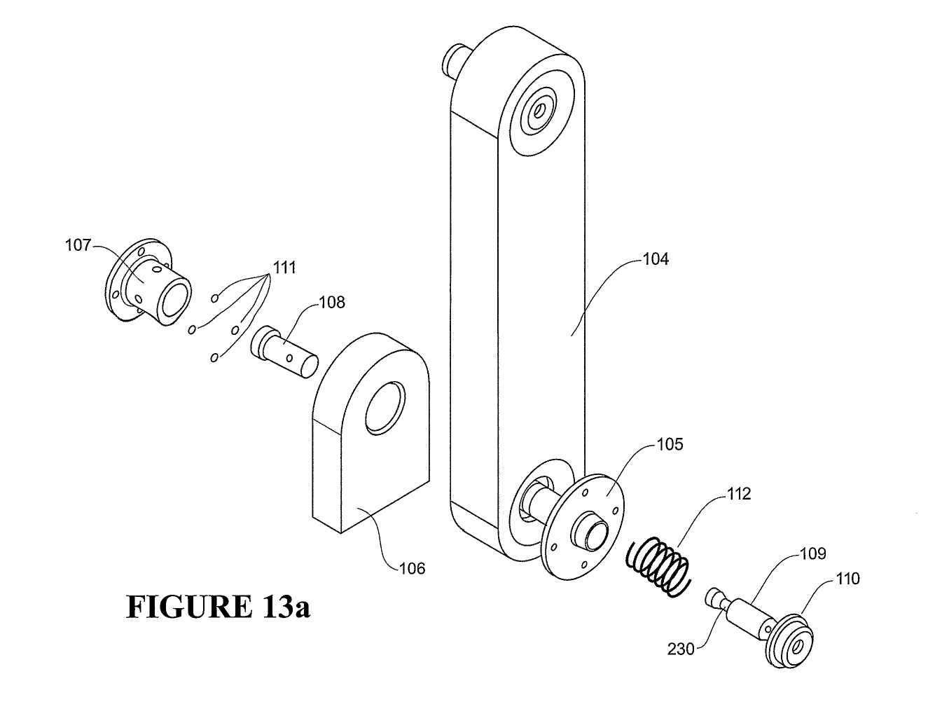

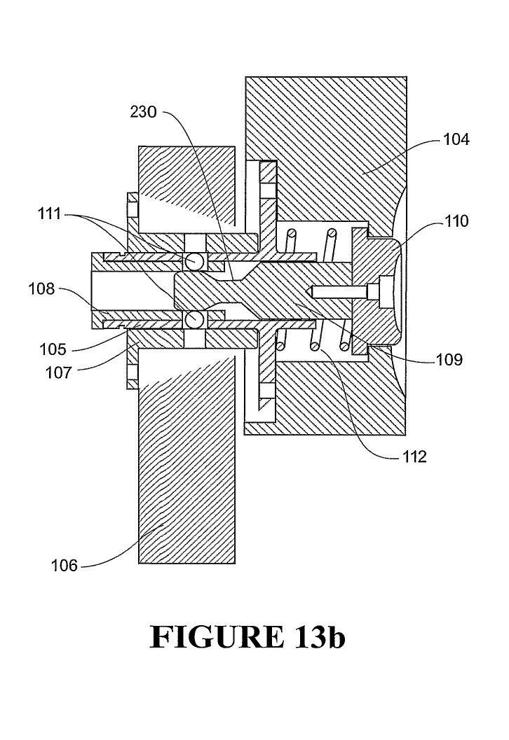

FIGS. 13a and 13b depict a snap-lock-ball system. Arm 104 has middle sleeve 105 rigidly attached to it and bracket 106 has outer sleeve 107 rigidly attached to it. Arm 104 can rotate with respect to bracket 106 around the axis defined by sleeves 105 and 107. There is a freely rotating inner sleeve 108 inside middle sleeve 105, and an actuation pin 109 inside inner sleeve 108. An actuation button 110 is attached to actuation pin 109, and this works against spring 112. Actuation pin 109 has a groove 230 near the end inserted inside inner sleeve 108. Each of the sleeves 105, 107 and 108 has four holes around their diameter. The holes in the inner sleeve 108 and middle sleeve 105 are sized to accept four ball bearings 111. The holes in the outer sleeve 107 are smaller than ball bearings 111. In the locked position actuation pin 109 and button 110 are held in the position shown in FIG. 13b by spring 112. Actuation pin 109 has a profile that forces the four ball bearings 111 into the position shown in FIG. 13b. This locks all of the sleeves together and prevents rotation. When the user presses the locking button 110, the actuation pin 109 moves so that the ball bearings 111 can fall into groove 230. The ball bearings 111 are then located entirely within the diameter occupied by inner sleeve 108 and actuation pin 109, and hence middle sleeve 107 is free to rotate 90 degrees with respect to outer sleeve 105. After 90 degrees of rotation, spring 112 forces actuation pin 109 and ball bearings 111 back into their locked position unless locking button 110 remains pressed.

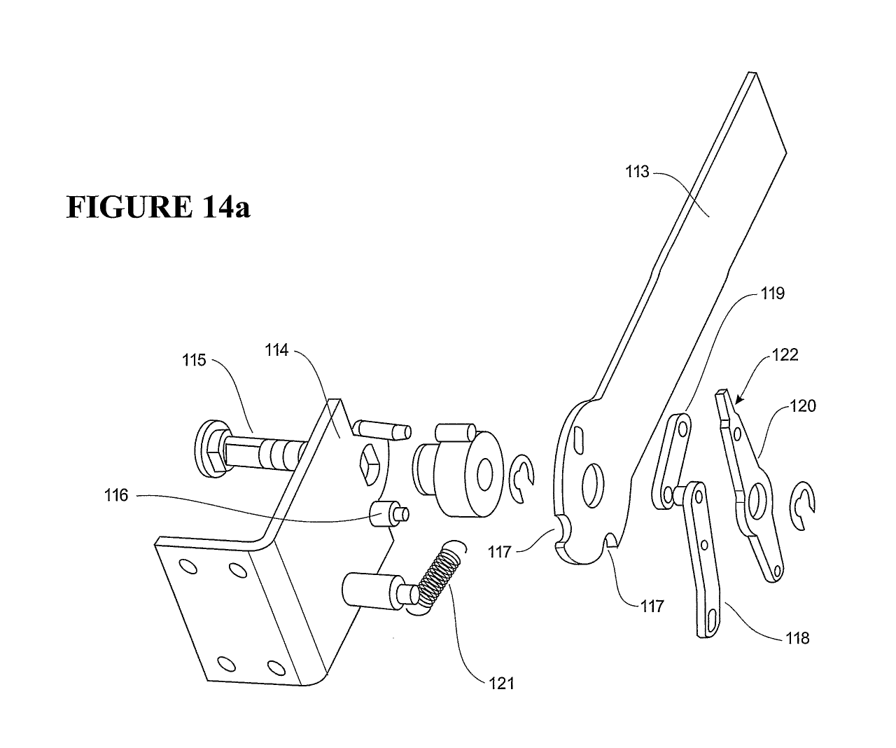

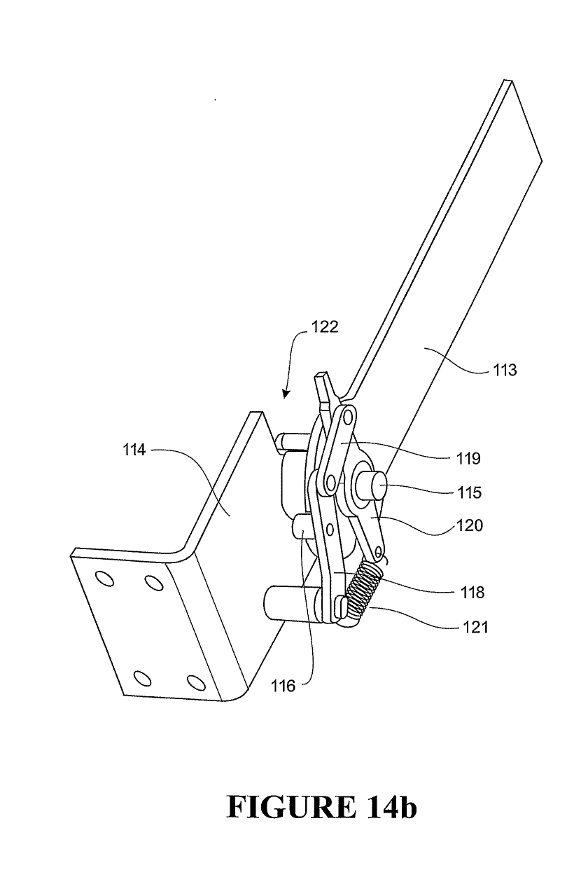

FIGS. 14a and 14b depict a latch-and-lock system. The arm 113 can rotate with respect to the bracket 114 around an axis defined by shaft 115. The arm 113 has an end profile that includes several indents 117 spaced at 90 degrees. A pin 116 is rigidly attached to lever arm 118. Lever arm 118 is attached to linkage 119 and release arm 120 by rotating joints, and release arm 120 can rotate around the axis of shaft 115. A spring 121 attaches to the end of the release arm 120. Normally, the spring 121 tensions the system comprising the pin 116, lever arm 118, linkage 119 and release arm 120 so that pin 116 is held in contact with the profiled end of the arm 113. When in the locked position the pin 116 engages with one of the indents 117. If the user presses the release lever 120 in the direction shown by the arrow 122, the linkage 119 pushes against the lever arm 118, and causes the pin 116 to disengage from whichever indent 117 it was engaged with. The arm 113 can then rotate around the bracket 114 for 90 degrees until pin 116 falls into another indent 117 and this will lock the arm position again.

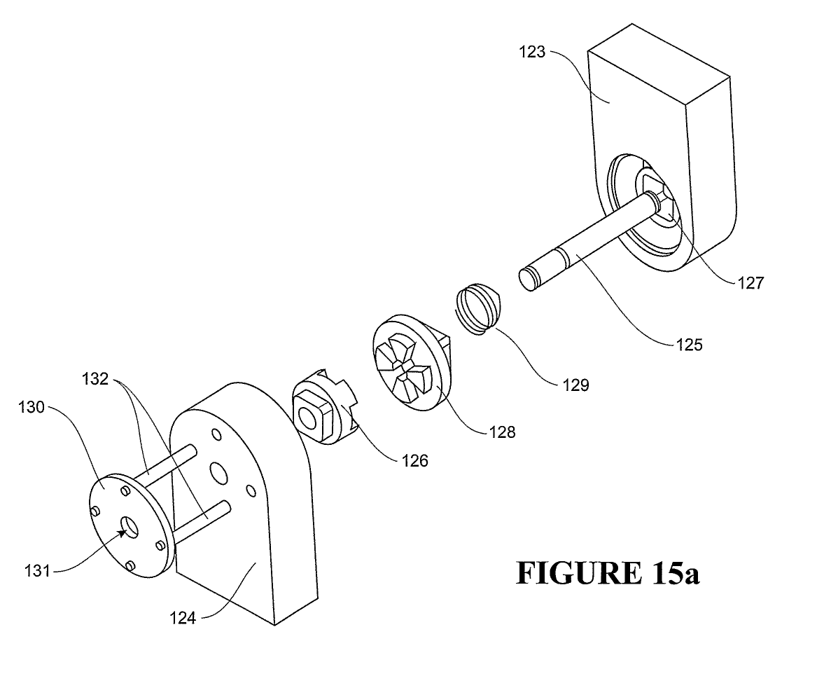

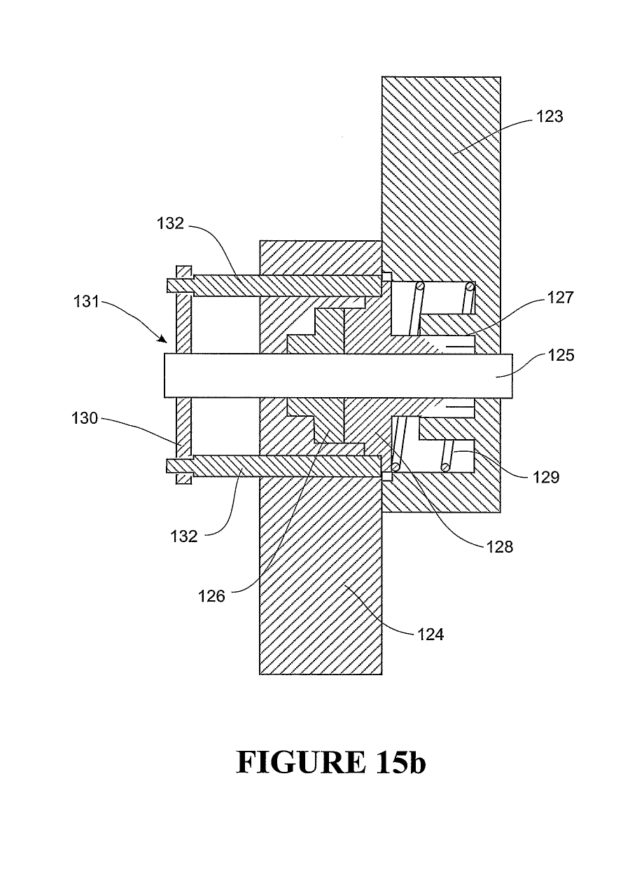

FIGS. 15a and 15b depict a dog-clutch system. The arm 123 can rotate with respect to the bracket 124 around an axis defined by the shaft 125. The bracket 124 is rigidly attached to a clutch-plate 126. The arm 123 has a shaped hole 127 (in this case square) that mates with a matching profile on the back of clutch-plate 128. The clutch-plate 128 cannot rotate with respect to the arm 123, but can slide along the shaft. The two clutch-plates 126 and 128 have mating features that have a rotational symmetry of 90 degrees. Normally, the two clutch-plates 126 and 128 are held together by a spring 129 and the arm 123 cannot rotate with respect to the bracket 124. When the user presses release button 130 in the direction shown by the arrow 131, the pins 132 press against clutch-plate 128 which slides along the shaft 125 and is disengaged from the clutch-plate 126. The arm 123 rotates around bracket 124 for 90 degrees until the two clutch-plates 126, 128 engage again.

1. A low-vision apparatus that displays the image of an object, said apparatus comprising:
a support including a connection for a surface on which to place the object to be viewed;
a head unit connected to said support, said head unit in use substantially above the object to be viewed;
a camera, integral or engaged with said head unit in use capturing a visual field including at least part of said object;
a display integral or engaged with said head unit and/or said support displaying at least part of said captured visual field; and
lighting integral or engaged with said head unit and/or said support for illuminating said visual field.

2. A low-vision apparatus according to claim 1 further comprising:
a base upon the object to be viewed is in use placed; wherein said support connected to said base; and wherein said display and said lighting are integral or engaged with said head unit, said base unit and/or said support.

3. A low-vision apparatus according to claim 2 wherein said base is hingably connected to said support.

4. A low-vision apparatus according to any one of claims 1 to 3 wherein said support is hingably connected to said head unit.

5. A low-vision apparatus according to any one of claims 1 to 4 wherein said display is hingably connected to said head unit.

6. A low-vision apparatus according to any one of claims 3 to 5 wherein said hinges are self locking at one or more orientations and a manually unlocking mechanism.

7. A low-vision apparatus according to claim 3 wherein the back of said base is hinged to the bottom of said support.

8. A low-vision apparatus according to claim 4 wherein the top of said support is hinged to the back of said head unit.

9. A low-vision apparatus according to claim 5 wherein the back of said display is hinged to the front of said head unit.

10. A low-vision apparatus according to claim 9 wherein said display is detachable from said head unit.

11. A low-vision apparatus according to any one of claims 2 to 10 wherein said display, said head unit, said support and said base fold relative to one another to fold said low-vision apparatus to a compact configuration.

12. A low-vision apparatus according to claim 11 wherein said apparatus includes a handle to carry said apparatus during transportation.

13. A low-vision apparatus according to claim 11 or 12 wherein said apparatus when folded is portable.

14. A low-vision apparatus according to any one of claims 11 to 13 wherein said apparatus is lightweight.

15. A low-vision apparatus according to any one of claims 11 to 14 wherein said apparatus when folded can be carried using one hand.

16. A low-vision apparatus according to any one of claims 1 to 15 wherein said lighting includes one or more sets of light sources consisting of one or more lights mounted on one or more of the said head unit, said support or said display.

17. A low-vision apparatus according to any one of claims 1 to 16 wherein said camera is on said head unit, oriented in use to point the visual field at the object to be viewed.

18. A low-vision apparatus according to any one of claims 1 to 16 wherein said camera is on said support, oriented in use to point the visual field at the object to be viewed.

19. A low-vision apparatus according to claim 17 or 18 wherein said camera operates in single capture and repetitive capture modes.

20. A low-vision apparatus according to claim 19 wherein one or more said sets of light sources is selectively activated by a controller dependent on said modes.

21. A low-vision apparatus according to claim 16 wherein said lighting is shielded.

22. A low-vision apparatus according to claim 21 wherein said lighting includes a specular reflection shield.

23. A low-vision apparatus according to claim 22 wherein said shield comprises at least one first linear polarised filter to polarise the light shining on said base, and said camera has at least one second linear polarised filter mounted in front of it, whereby the polarisation angle of said second linear polarised filter is oriented at 90 degrees to that of said first linear polarised filter.

24. A low-vision apparatus according to claim 23 wherein said first linear polarised filter comprises a plurality of polarising filters.

25. A low-vision apparatus according to claims 21 or 22 wherein said shield comprises a mechanical louver in front of said sets of light sources.

26. A low-vision apparatus according to claims 21 or 22 wherein said shield comprises a prismatic lens in front of said sets of light sources.

27. A low-vision apparatus according to any one of claims 21 to 26 wherein said sets of light sources are shielded so that each light source illuminates the opposite side of said visual field than the side they are mounted on.

28. A low-vision apparatus according to any one of claims 1 to 27 wherein said low-vision apparatus includes a data processing unit connected intermediate of said display means and said camera, said processing unit defining said visual field as a set of pixels and a subset of said set of pixels as a window-of-interest and said low-vision apparatus including a selection tool to select said subset of pixels on said visual field which constitutes the window-of-interest.

29. A low-vision apparatus that displays the image of an object, said apparatus comprising:
a support structure
a camera attached to said support structure, in use capturing a visual field about said object, including at least one first linear polarised filter;
a display attached to said support structure displaying at least part of said captured visual field; and
lighting attached to said support structure for lighting said visual field, including at least one second linear polarised filter, whereby the polarisation angle of said second linear polarised filter is oriented at 90 degrees to that of said first linear polarised filter.

30. A low-vision apparatus that displays the image of an object, said apparatus comprising:
a support structure;
a camera attached to said support structure, in use capturing a visual field about said object;
a display attached to said support structure displaying at least part of said captured visual field;
lighting attached to said support structure for lighting said visual field; and
a controller selectively activating said camera into either a single capture mode or a repetitive capture mode, and selectively activating said lighting depending on said modes.

31. A low-vision apparatus that displays the image of an object, said apparatus comprising:
a support structure;
a camera attached to said support structure, in use capturing a visual field about said object;
a display attached to said support structure displaying at least part of said captured visual field; and
lighting attached to said support structure for lighting said visual field, including a specular reflection shield.

32. A transportable low-vision apparatus that displays the image of an object, said apparatus comprising:
a camera, in use capturing a visual field about said object;
a display displaying at least part of said captured visual field;
lighting for lighting said visual field; and
a support structure either connected and/or configurable connected to said camera, said display and said lighting, wherein said support structure, said camera, said display and said lighting are configurable to a compact configuration for transportation.

33. A low vision apparatus according to any one of the embodiments described herein with reference to and illustrated by any of FIGS. 2 to 17.
